(19) United States
(12) Patent Application Publication
(10) Pub. No.: US 2025/0059380 A1
(43) Pub. Date: Feb. 20, 2025

(54) AQUEOUS COATING COMPOSITION

(71) Applicant: Dow Global Technologies LLC, Midland, MI (US)

(72) Inventors: Weijun Yang, Shanghai (CN); Longlan Cui, Shanghai (CN)

(21) Appl. No.: 18/721,712

(22) PCT Filed: Dec. 24, 2021
(86) PCT No.: PCT/CN2021/141221

§ 371 Date: Jun. 19, 2024

(51) Int. Cl. C09D 5/02; C09D 7/65; C09D 125/14

(52) U.S. Cl. CPC C09D 5/022; C09D 7/65; C09D 125/14

(57) ABSTRACT

An aqueous coating composition contains: (A) a polyacid polymer containing a phosphonate and/or phosphinate functional group, wherein the polyacid polymer has a weight average molecular weight of 2000 to 25000 g/mol and comprises, by weight based on the weight of the polyacid polymer, from 20% to 100% of structural units of an acid monomer, a salt thereof, or mixtures thereof; and from zero to 80% of structural units of an ethylenically unsaturated nonionic monomer; (B) an emulsion polymer comprising, by weight based on the weight of the emulsion polymer, from 0.3% to 2.5% of structural units of an ethylenically unsaturated phosphorous-containing acid monomer, a salt thereof, or mixtures thereof; from zero to 10% of structural units of an additional acid monomer, a salt thereof, or mixtures thereof; and structural units of an ethylenically unsaturated nonionic monomer; (C) from 0.005% to 0.15%, by weight based on the weight of the aqueous coating composition, of a polyethylenimine, a modified polyethylenimine, or mixtures thereof; having a weight average molecular weight of 500 to 50000 grams per mole; and (D) a pigment, an extender, or mixtures thereof; where the coating composition has a pigment volume concentration of 78% to 86%.

### FIELD

The present invention relates to an aqueous coating composition and a process for preparing the same.

### INTRODUCTION

Aqueous or waterborne coating compositions are becoming increasingly more important than solvent-based coating compositions for less environmental problems. Aqueous coating compositions with a high pigment volume concentration (PVC) (e.g., a PVC of 65% or higher) occupy a great share in the architecture coating industry due to the low cost. One of desirable properties for interior wall coatings is the coatings' resistance to erosion when repeatedly scrubbed during the life of the coatings (also as “washability”). Incorporation of phosphorous-containing monomers into emulsion polymer binders can improve washability of coatings comprising thereof. However, coating compositions comprising emulsion polymers prepared by including 0.3% by weight or more, based on the total monomer weight, of phosphorous-containing acid monomers usually suffer from storage stability issues, particularly in high PVC compositions. What is needed is an aqueous coating composition with a combination of storage stability and good washability.

It is desirable to provide a high PVC coating composition without the aforementioned problems.

### SUMMARY

The present invention solves the problem of discovering a novel aqueous coating composition without the aforementioned problems. The present invention provides a novel combination of a phosphonate and/or phosphinate functional polyacid polymer, a specific emulsion polymer comprising structural units of a phosphorous-containing acid monomer and/or salt thereof, and a specific polyethylenimine or modified polyethylenimine; at a specific high pigment volume concentration. The coating composition of the present invention is storage stable, as indicated by a viscosity change of 20 Krebs Units (KU) or less after storage at 25 degree Celsius (° C.) for 18 hours and further at 50° C. for 10 days, while providing coatings with desired washability. The properties above are measured according to the test methods described in the Examples section below.

In a first aspect, the present invention is an aqueous coating composition comprising:

(A) a polyacid polymer containing a phosphonate and/or phosphinate functional group, wherein the polyacid polymer has a weight average molecular weight of 2000 to 25000 grams per mole (g/mol) and comprises, by weight based on the weight of the polyacid polymer, from 20% to 100% of structural units of an acid monomer, a salt thereof, or mixtures thereof; and from zero to 80% of structural units of an ethylenically unsaturated nonionic monomer;

(B) an emulsion polymer comprising, by weight based on the weight of the emulsion polymer, from 0.3% to 2.5% of structural units of an ethylenically unsaturated phosphorous-containing acid monomer, a salt thereof, or mixtures thereof; from zero to 10% of structural units of an additional acid monomer, a salt thereof, or mixtures thereof; and structural units of an ethylenically unsaturated nonionic monomer;

(C) from 0.005% to 0.15%, by weight based on the weight of the aqueous coating composition, of a polyethylenimine, a modified polyethylenimine, or mixtures thereof; having a weight average molecular weight of 500 to 50000 g/mol; and

(D) a pigment, an extender, or mixtures thereof;

wherein the coating composition has a pigment volume concentration of 78% to 86%.

In a second aspect, the present invention is a process for preparing the aqueous coating composition of the first aspect. The process comprises admixing the polyacid polymer (A), the emulsion polymer (B), the polyethylenimine, the modified polyethylenimine, or mixtures thereof (C), and the pigment, the extender, or mixtures thereof (D).

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods.

Products identified by their tradename refer to the compositions available under those tradenames on the priority date of this document. “And/or” means “and, or as an alternative”. All ranges include endpoints unless otherwise indicated.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

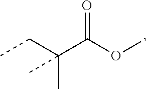

where the dotted lines represent the points of attachment of the structural unit to the polymer backbone.

“Polyacid polymer” herein refers to a homopolymer of an acid monomer or a copolymer of an acid monomer with a different acid monomer and/or other monomers such as ethylenically unsaturated nonionic monomers, e.g., styrene and vinyl acetate.

“Nonionic monomer” herein refers to a monomer that does not bear an ionic charge between pH=1-14.

Throughout this document, the word fragment “(meth)acryl” refers to both “methacryl” and “acryl”. For example, (meth) acrylic acid refers to both methacrylic acid and acrylic acid, and methyl (meth)acrylate refers to both methyl methacrylate and methyl acrylate.

“Glass transition temperature” or “T_{g}” as used herein can be calculated by using a Fox equation (T. G. Fox, Bull. Am. Physics Soc., Volume 1, Issue No. 3, page 123 (1956)) below. For example, for calculating the T_{g} of a copolymer of monomers M₁ and M₂,

$$\frac{1}{{T}_{g} ( c alc . )} = \frac{w ( {M}_{1} )}{{T}_{g} ( {M}_{1} )} + \frac{w ( {M}_{2} )}{{T}_{g} ( {M}_{2} )} ,$$

where T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E. H. Immergut, Interscience Publishers.

The coating composition of the present invention comprises one or more polyacid polymers containing a phosphinate and/or phosphonate functional group. The polyacid polymer may contain a phosphinate endgroups, phosphonate endgroups, and/or phosphinate groups in the middle of the polymer chain. The phosphinate group and/or phosphonate group in the polymer can be as illustrated by (I), (II), (III) or combinations thereof:

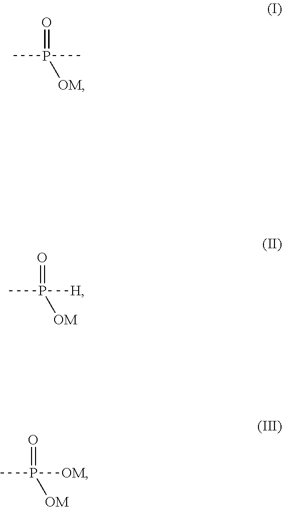

where the dotted lines represent the points of attachment of the phosphinate and/or phosphonate functional group to the polymer backbone, and M represents H or a metal ion such as Na⁺ or K⁺.

The polyacid polymer useful in the present invention comprises structural units of one or more acid monomers, salts thereof, or mixtures thereof. The acid monomers and/or salts thereof can be an ethylenically unsaturated carboxylic acid monomer; an ethylenically unsaturated sulfonic acid monomer; or an ethylenically unsaturated phosphorous-containing acid monomer; salts thereof (e.g., water soluble salts such as sodium or potassium salts); or combinations thereof. Desirably, the acid monomer is an ethylenically unsaturated carboxylic acid monomer.

The ethylenically unsaturated carboxylic acid monomer useful in the present invention can be an α, β-ethylenically unsaturated carboxylic acid monomer, which also include a monomer bearing an acid-forming group which yields or is subsequently convertible to, such an acid group (such as anhydride, (meth)acrylic anhydride, or maleic anhydride). Specific examples of carboxylic acid monomers include (a) monocarboxylic acids such as acrylic acid, methacrylic acid, ethylacrylic acid, crotonic acid, allylacetic acid, vinylacetic acid, acryloxypropionic acid, or mixtures thereof; (b) dicarboxylic acids and anhydrides thereof such as itaconic acid, fumaric acid, dimethacrylic acid, mesaconic acid, methylenemalonic acid, citraconic acid, maleic acid, maleic anhydride; or mixture thereof; or combinations of (a) and (b). The polyacid polymer may comprise structural units of the ethylenically unsaturated carboxylic acid monomer and/or salt thereof at a concentration of 20% or more, and can be 30% or more, 40% or more, 50% or more, 60% or more, 70% or more, 80% or more, or even 90% or more, while at the same time is generally 100% or less, and can be 99% or less, 95% or less, or even 90% or less, by weight based on the weight of the polyacid polymer. “Weight of the polyacid polymer” in the present invention refers to dry weight of the polyacid polymer.

The ethylenically unsaturated sulfonic acid monomer and/or salt thereof useful in the present invention may be selected from sodium styrene sulfonate (SSS), 2-acrylamido-2-methylpropanesulfonic acid (AMPS), and sodium vinyl sulfonate (SVS); salts thereof such as sodium 2-acrylamido-2-methylpropane sulfonate; or mixtures thereof. The polyacid polymer may comprise structural units of the ethylenically unsaturated sulfonic acid monomer and/or salt thereof at a concentration of zero or more, and can be 1% or more, 5% or more, or even 10% or more, while at the same time is generally 80% or less, and can be 70% or less, 60% or less, or even 50% or less, by weight based on the weight of the polyacid polymer.

The ethylenically unsaturated phosphorous-containing acid monomer and/or salt thereof useful in the present invention can be dihydrogen phosphate esters of an alcohol in which the alcohol contains or is substituted with a polymerizable vinyl or olefinic group. Suitable ethylenically unsaturated phosphorous-containing acid monomers and salts thereof may include, for example, phosphoalkyl (meth)acrylates such as 2-phosphoethyl (meth)acrylate, 2-phosphopropyl (meth)acrylate, 3-phosphopropyl (meth)acrylate, phosphobutyl (meth)acrylate, 3-phospho-2-hydroxypropyl (meth)acrylate, salts of phosphoalkyl (meth)acrylates, and mixtures thereof; mono-or di-phosphates of bis (hydroxymethyl) fumarate or itaconate; CH₂═C(R)—C(O)—O—(RₚO)_{q}—P(O)(OH)₂, wherein R═H or CH₃ and Rₚ═C₁-C₄ alkylene such as —CH₂CH₂—, subscript q is from 1 to 50, such as SIPOMER PAM-100, SIPOMER PAM-200, SIPOMER PAM-300, and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate; allyl phosphate, salts thereof; phosphates of hydroxyalkyl(meth)acrylate such as 2-hydroxyethyl (meth)acrylate, 3-hydroxypropyl(meth)acrylate and ethylene oxide condensates of (methacrylates; phosphoalkyl crotonates; phosphoalkyl maleates; phosphoalkyl fumarates; phosphodialkyl (meth)acrylates; phosphodialkyl crotonates; vinyl phosphonic acid; allyl phosphonic acid; 2-acrylamido-2-methylpropanephosphinic acid; α-phosphonostyrene; 2-methylacrylamido-2-methylpropa-nephosphinic acid, (hydroxy)phosphinylalky(meth)acrylates, (hydroxy)phosphinylmethyl methacrylate; or combinations thereof. Desirably, the ethylenically unsaturated phosphorous-containing acid monomer is selected from phosphoethyl methacrylate, phosphoethyl acrylate, allyl ether phosphate, phosphopropyl methacrylate, phosphobutyl methacrylate, or mixtures thereof. The polyacid polymer may comprise structural units of the ethylenically unsaturated phosphorous-containing acid monomer and/or salt thereof at a concentration of zero or more, and can be 1% or more, 5% or more, or even 10% or more, while at the same time is generally 80% or less, and can be 70% or less, 60% or less, or even 50% or less, by weight based on the weight of the polyacid polymer.

The polyacid polymer useful in the present invention may comprise structural units of the acid monomer and/or salt thereof at a total concentration of 20% or more, and can be 30% or more, 40% or more, 50% or more, 55% or more, 60% or more, 65% or more, 70% or more, 75% or more, 80% or more, 85% or more, or even 90% or more, while at the same time is 100% or less, and can be 99% or less, 98% or less, 95% or less, 92% or less, or even 90% or less, by weight based on the weight of the polyacid polymer.

The polyacid polymer useful in the present invention may comprise or be free of structural units of one or more ethylenically unsaturated nonionic monomers, and desirably, monoethylenically unsaturated nonionic monomers. Suitable examples of the ethylenically unsaturated nonionic monomers include, for example, alkyl esters of (meth)acrylic acids such as methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate; alkoxylated (meth)acrylates such as methoxy polyethylene glycol methacrylate; hydroxy-functional alkyl (meth)acrylates such as hydroxyethyl methacrylate and hydroxypropyl methacrylate; (meth)acrylonitrile; (meth)acrylamide; amino-functional and ureido-functional monomers; acetoacetoxy functional monomers such as acetoacetoxyethyl methacrylate (AAEM); vinyl aromatic monomers such as styrene and substituted styrenes; vinyl acetate, vinyl butyrate, vinyl versatate and other vinyl esters; or mixtures thereof. The polyacid polymer may comprise structural units of the ethylenically unsaturated nonionic monomer at a concentration of zero or more, and can be 1% or more, 2% or more, 3% or more, 5% or more, or even 8% or more, while at the same time is generally 80% or less, 60% or less, 40% or less, 20% or less, or even 10% or less, by weight based on the weight of the polyacid polymer.

Desirably, the polyacid polymer comprises, by weight based on the weight of the polyacid polymer, from 70% to 100% of structural units of the ethylenically unsaturated carboxylic acid monomer and from zero to 30% of structural units of the ethylenically unsaturated nonionic monomer, and optionally, from zero to 50% of structural units of the ethylenically unsaturated sulfonic acid monomer and/or salt thereof, from zero to 50% of structural units of the ethylenically unsaturated phosphorous-containing acid monomer and/or salt thereof; where the total concentration of these structural units can be 100%. More desirably, the polyacid polymer comprises, by weight based on the weight of the polyacid polymer, from 70% to 100% of structural units of acrylic acid and from zero to 30% of structural units of maleic acid.

The polyacid polymer useful in the present invention may be prepared by any aqueous solution polymerization processes known in the art, for example, polymerization of monomers in an aqueous medium in the presence of a phosphorous chain transfer agent, and optionally one or more water-soluble thermal or redox initiators, one or more water soluble metal salts as polymerization promotors, and/or one or more inorganic or organic bases as neutralizers. The monomers for preparing the polyacid polymer include those described above, such as the acid monomer and/or salt thereof, and optionally, the ethylenically unsaturated nonionic monomer. The weight concentration of each monomer used in the process relative to the total monomer weight can be the same as the weight concentration of structural units of such monomer relative to the weight of the polyacid polymer. Total weight concentration of monomers for preparing the polyacid polymer is equal to 100%, relative to total monomer weight. A mixture of monomers for preparing the polyacid polymer, may be added as a monomer solution in water or as an emulsion in water or added in one or more additions or continuously, linearly or nonlinearly, over the reaction period of preparing the polyacid polymer. Temperatures suitable for the polymerization process depend on the choice of the initiator and target molecular weight. Generally, the temperature of the polymerization is up to the boiling point of the system although the polymerization can be conducted under pressure if higher temperatures are used. Desirably, the temperature of polymerization is from 45 to 110° C. or from 60 to 105° C.

In the polymerization process for preparing the polyacid polymer, water-soluble initiators can be used. The polymerization process may be thermally initiated or redox initiated aqueous solution polymerization. Suitable initiators may include, for example, sodium persulfate, hydrogen peroxide, certain alkyl hydroperoxides, dialkyl peroxides, peresters, percarbonates, ketone peroxides, azoinitiators, tert-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. Desirably, the initiator is selected from hydrogen peroxide, sodium persulfate, tert-butyl hydroperoxide, ammonium persulfate, potassium persulfate, tert-amyl hydroperoxide and methyl ethyl ketone peroxide. The initiator may be used in an amount of from 0.01% to 30%, from 0.5% to 20%, from 1% to 15%, or from 2% to 10%, by weight based on the total monomer weight. Water-soluble redox systems comprising the above described initiators coupled with a suitable reductant may be used in the polymerization process. Examples of suitable reductants include formaldehyde, ascorbic acid, isoascorbic acid, sodium formaldehyde-sulfoxylate and hydroxylamines, alkali metal and ammonium salts of sulfur-containing acids, such as sodium sulfite, bisulfite, thiosulfate, hydrosulfite, sulfide, hydrosulfide, sulfoxylate or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

The phosphorous chain transfer agents useful for preparing the polyacid polymer can be hypophosphorous acid or phosphorous acid; salts thereof, or combinations thereof. “Salts” herein may include alkali and alkaline earth metal salts such as sodium salts and ammonium salts. Specific examples of salts of hypophosphorous acid and/or phosphorous acid include sodium phosphite, ammonium phosphite, hypophosphites, or mixtures thereof. All or at least a portion of the phosphorous chain transfer agent enters into the chain transfer process and becomes incorporated into the polymer chain with phosphonate and/or phosphinate functionality. The phosphorous chain transfer agent may be used in the process at a concentration of 1% or more, and can be 2% or more, or even 5% or more, while at the same time is generally 25% or less, and can be 20% or less, 15% or less, or even 10% or less, by weight based on the total monomer weight.

In the polymerization process for preparing the polyacid polymer, one or neutralizers may be added prior to and/or during the polymerization. Desirably, the neutralizer is present during the polymerization. Specific examples of bases include alkali metal or alkaline earth metal compounds such as sodium hydroxide and potassium hydroxide, ammonium hydroxide, triethanolamine, dimethylaminoethanol, ethanolamine and trimethylhydroxyethylammonium hydroxide. The obtained polyacid polymer may have a pH value of from 2.5 to 10, from 4 to 9.5, or from 6 to 9.

The process for preparing the polyacid polymer can result in low molecular weight water-soluble polymers with phosphonate and/or phosphinate moieties incorporated into the polymers. The polyacid polymer may have a weight average molecular weight (Mw) of 2,000 grams per mole (g/mol) or more, and can be 5,000 g/mol or more, 6,000 g/mol or more, 7,000 g/mol or more, 8,000 g/mol or more, 9,000 g/mol or more, 10,000 g/mol or more, or even 11,000 g/mol or more, while at the same time is generally 25,000 g/mol or less, and can be 24,000 g/mol or less, 23,000 g/mol or less, 22,000 g/mol or less, 21,000 g/mol or less, 20,000 g/mol or less, 19,000 g/mol or less, 18,000 g/mol or less, 17,000 g/mol or less, 16,000 g/mol or less, 15,000 g/mol or less, or even 14,000 g/mol or less, as determined by Gel Permeation Chromatography (GPC) analysis (further details provided below under GPC Analysis for Polyacid Polymer).

The polyacid polymer useful in the present invention can be used as a dispersant in the coating composition. The coating composition may comprise the polyacid polymer at a concentration of 0.1% or more, and can be 0.2% or more, 0.3% or more, 0.4% or more, 0.5% or more, 0.6% or more, 0.7% or more, or even 0.8% or more, while at the same time is generally 3% or less, and can be 2.8% or less, 2.5% or less, 2% or less, 1.8% or less, 1.5% or less, 1.4% or less, 1.3% or less, 1.2% or less, 1.1% or less, 1.0% or less, 0.9% or less, or even 0.8% or less, by weight based on the total weight of the pigment and extender.

The coating composition of the present invention also comprises one or more emulsion polymers (B). The emulsion polymers can be used as binders in the coating composition. The emulsion polymer comprises structural units of one or more ethylenically unsaturated phosphorous-containing acid monomers, salts thereof, or mixtures thereof. The ethylenically unsaturated phosphorous-containing acid monomer and/or the salt thereof may include those described above in the polyacid polymer section. Desirably, the ethylenically unsaturated phosphorous-containing acid monomer and/or the salt thereof is selected from phosphoethyl (meth)acrylate, phosphopropyl (meth)acrylate, phosphobutyl (meth)acrylate, allyl ether phosphate, salts thereof, or mixtures thereof. The emulsion polymer may comprise structural units of the ethylenically unsaturated phosphorous-containing acid monomer and/or salt thereof at a concentration of 0.3% or more, and can be 0.4% or more, 0.5% or more, 0.6% or more, 0.65% or more, 0.7% or more, 0.8% or more, 1.0% or more, 1.2% or more, or even 1.5% or more, while at the same time is generally 2.5% or less, and can be 2.4% or less, 2.3% or less, 2.2% or less, 2.1% or less, 2.0% or less, 1.9% or less, 1.8% or less, 1.7% or less, 1.6% or less, or even 1.5% or less, by weight based on the weight of the emulsion polymer.

The emulsion polymer useful in the present invention may comprise or be free of structural units of one or more additional acid monomers other than the ethylenically unsaturated phosphorous-containing acid monomer and the salt thereof. The additional acid monomer is selected from an ethylenically unsaturated carboxylic acid monomer, an ethylenically unsaturated sulfonic acid monomer, salts thereof, or mixtures thereof. These monomers and salts thereof may include those described above in the polyacid polymer section. Desirably, the ethylenically unsaturated carboxylic acid monomer is selected from acrylic acid, methacrylic acid, or mixtures thereof. Desirably, the ethylenically unsaturated sulfonic acid monomer is selected from sodium styrene sulfonate (SSS), or 2-acrylamido-2-methylpropanesulfonic acid (AMPS); salts thereof; or mixtures thereof. The emulsion polymer may comprise structural units of the additional acid monomer and/or salt thereof at a concentration of zero or more, and can be 0.1% or more, 0.5% or more, 0.8% or more, or even 1.0% or more, while at the same time is generally 10% or less, and can be 8% or less, 5% or less, 4% or less, 3% or less, 2% or less, or even 1% or less, by weight based on the weight of the emulsion polymer.

The emulsion polymer may comprise or be free of structural units of one or more acetoacetoxy functional monomers. The acetoacetoxy functional monomers may include, for example, acetoacetoxyalkyl (meth)acrylates such as acetoacetoxyethyl (meth)acrylate, acetoacetoxypropyl (meth)acrylate, acetoacetoxybutyl (meth)acrylate, 2,3-di(acetoacetoxy)propyl (meth)acrylate, or mixtures thereof; allyl acetoacetate; vinyl acetoacetate; or combinations thereof. Desirably, the acetoacetoxy functional monomer is acetoacetoxyethyl methacrylate (AAEM). The emulsion polymer may comprise structural units of the acetoacetoxy functional monomer at a concentration of from zero to 10%, from 2% to 8%, or from 3% to 6%, by weight based on the weight of the emulsion polymer.

The emulsion polymer useful in the present invention may comprise structural units of one or more ethylenically unsaturated nonionic monomers other than the acetoacetoxy functional monomer. The ethylenically unsaturated nonionic monomers may include those described above in the polyacid polymer section. Desirably, the ethylenically unsaturated nonionic monomer is selected from alkyl esters of (meth)acrylic acids such as methyl acrylate, ethyl acrylate, butyl acrylate, 2-ethylhexyl acrylate, methyl methacrylate, butyl methacrylate, styrene, or mixtures thereof. The emulsion polymer may comprise structural units of the ethylenically unsaturated nonionic monomer at a concentration of 55% or more, and can be 60% or more, 65% or more, 70% or more, 75% or more, 80% or more, 85% or more, or even 90% or more, while at the same time is generally 99.6% or less, and can be 99.5% or less, 99% or less, 98.5% or less, 98% or less, 97.5% or less, 97% or less, 96% or less, 95% or less, 92% or less, or even 90% or less, by weight based on the weight of the emulsion polymer.

The emulsion polymer useful in the present invention can be prepared by a conventional process known in the art, e.g., emulsion polymerization of the monomers described above, such as the ethylenically unsaturated phosphorous-containing acid monomer and/or salt thereof, and the ethylenically unsaturated nonionic monomer, and optionally, the additional acid monomer and/or salt thereof, and the acetoacetoxy functional monomer. The weight concentration of each monomer used in the process relative to the total monomer weight can be the same as the weight concentration of structural units of such monomer relative to the weight of the emulsion polymer. Total weight concentration of monomers for preparing the emulsion polymer is equal to 100%, relative to total monomer weight. For example, one or more surfactants may be used. The surfactants may be added prior to or during the polymerization of the monomers, or combinations thereof. A portion of the surfactant can also be added after the polymerization. These surfactants may include anionic and/or nonionic emulsifiers. Examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. The surfactant may be used in an amount of from zero to 10%, and desirably, from 0.05% to 3%, by weight based on the weight of total monomers used for preparing the emulsion polymer. One or more chain transfer agents may be used in the polymerization process for preparing the emulsion polymer. Examples of suitable chain transfer agents used in emulsion polymerization include those phosphorous chain transfer agents described in the polyacid polymer above, n-dodecylmercaptan (nDDM), 3-mercaptopropionic acid, methyl 3-mercaptopropionate (MMP), butyl 3-mercaptopropionate (BMP), benzenethiol, azelaic alkyl mercaptan, or mixtures thereof. The chain transfer agent may be used in an effective amount to control the molecular weight of the emulsion polymer, for example, in an amount of from zero to 5%, from 0.05% to 2%, from 0.1% to 1%, or from 0.15% to 0.75%, by weight based on the total weight of monomers used for preparing the emulsion polymer.

The emulsion polymer useful in the present invention typically has higher molecular weight than that of the polyacid polymer. For example, the emulsion polymer may have a weight average molecular weight (Mw) of from 50,000 to 3,000,000 g/mol, from 100,000 to 2,000,000 g/mol, from 150,000 to 1,500,000 g/mol, from 200,000 to 1,000,000 g/mol, from 300,000 to 800,000 g/mol, or from 400,000 to 600,000 g/mol, as determined by Gel Permeation Chromatography (GPC) relative to polystyrene standards.

The emulsion polymer useful in the present invention may have a Tg of from −50 to 50° C., from −40 to 40°° C., from −35 to 35° C., from −25 to 25° C., or from −15 to 15° C., as calculated by the Fox equation.

Particles of the emulsion polymer dispersed in the aqueous coating composition may have a particle size of 30 nanometers (nm) or more, and can be 50 nm or more, 60 nm or more, 70 nm or more, or even 80 nm or more, while at the same time is generally 500 nm or less, and can be 300 nm or less, 200 nm or less, 150 nm or less, 120 nm or less, or even 100 nm or less. The particle size herein refers to the number average particle size measured by Brookhaven BI −90 Plus Particle Size Analyzer.

The coating composition of the present invention comprises one or more pigments, one or more extenders, or mixtures thereof. “Pigments” herein refers to organic or inorganic materials which are capable of materially contributing to the opacity, the color, or hiding capability of a composition. Such material typically has a refractive index greater than 1.8. Suitable examples of pigments may include, for example, titanium dioxide (TiO2), zinc sulfide, lithopone, carbon black, iron oxide, lemon chrome yellow, prussian blue, organic pigment yellow, organic pigment red, zinc phosphate, zinc molybdate, zinc oxide, aluminum tripolyphosphate, zinc phosphate molybdenum, calcium-modified zinc phosphate, or mixtures thereof. Desirably, the pigment is TiO₂. “Extender” herein refers to a particulate inorganic material having a refractive index of less than or equal to 1.8 and greater than 1.3. Examples of suitable extenders include barium sulphate, talc, calcium carbonate, clay, calcium sulfate, aluminum silicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The pigment and the extender are typically insoluble in the medium in which it is incorporated.

The pigment and/or extender may be present in an amount sufficient to provide a pigment volume concentration (PVC) of the coating composition in a range of 78% to 86%, and can be 78% or more, 79% or more, or even 80% or more, while at the same times is generally 86% or less, and can be 85% or less, 84% or less, 83% or less, 82% or less, 81% or less, or even 80% or less. PVC of a coating composition may be determined according to the equation:

PVC=[Volume (Pigment+Extender)/Volume(Pigment+Extender+Emulsion polymer)]×100%.

The coating composition of the present invention also comprise one or more polyethylenimines (PEIs), modified polyethylenimines, or mixtures thereof. The polyethylenimines can be linear or branched polyethylenimines. The linear polyethylenimines may have the structure of formula (A):

H₂N—[CH₂CH₂NH]ₙ—CH₂CH₂NH₂ (A)

where subscript n is greater than 1 (>1) and values of subscript n are sufficient to provide the desired molecular weight for polyethylenimines and/or modified polyethylenimines described below. The branched polyethylenimines may comprise the structure as follows:

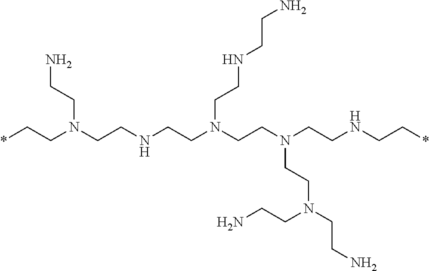 [SMILES: *CCNCCN(CCN(CCN)CCN)CCN(CCNCCN)CCNCCN(CC*)CCN]

Modified polyethylenimines may include alkoxylated polyethylenimines, amidated polyethylenimines, carboxylated polyethylenimines, or mixtures thereof. Polyethylenimines used for preparing the modified polyethylenimines are as described above. Suitable amidated polyethylenimines may include an amidation reaction product of a polyethylenimine with a fatty acid. The fatty acid herein can be a saturated or unsaturated fatty acid. Examples of suitable fatty acids include butyric acid, oleic acid, glucoic acid, lauric acid, palmitic acid, a-linolenic acid, linoleic acid, or mixtures thereof. Suitable alkoxylated polyethylenimines may include an alkoxylation reaction product of a polyethylenimine with one or more alkylene oxides such as ethylene oxide. Suitable carboxylated polyethylenimines may include a carboxylation reaction product of a polyethylenimine with (meth)acrylic acid and/or maleic acid. Suitable modified polyethylenimines may include those described in U.S. Pat. Nos. 10,774,034B2, 7,645,855B2, WO2016135000A1, WO2016118728A1, WO2020104303A1 and WO2018149760A1. The polyethylenimine and/or modified polyethylenimine can be dissolved in water or in any aqueous medium. Suitable commercially available aqueous solutions of polyethylenimines include, for example, Lupasol G 10, Lupasol G 20, Lupasol G 100 and Lupasol WF all available from BASF.

The polyethylenimine and/or modified polyethylenimine useful in the present invention may have a weight average molecular weight of 500 g/mol or less, and can be 800 g/mol or more, 1,000 g/mol or more, 1,200 g/mol or more, 1,500 g/mol or more, 2,000 g/mol or more, 2,500 g/mol or more, 3,000 g/mol or more, 5,000 g/mol or more, 8,000 g/mol or more, or even 10,000 g/mol or more, while at the same time is generally 50,000 g/mol or less, and can be 48,000 g/mol or less, 45,000 g/mol or less, 42,000 g/mol or less, 40,000 g/mol or less, 38,000 g/mol or less, or even 35,000 g/mol or less, as determined by GPC analysis (further details provided under GPC Analysis for Polyethylenimines below).

The polyethylenimine and/or modified polyethylenimine may be present at a concentration of 0.005% or more, and can be 0.01% or more, 0.02% more, 0.03% or more, 0.04% or more, 0.05% or more, while at the same time is generally 0.15% or less, and can be 0.14% or less, 0.12% or less, 0.1% or less, 0.08% or less, 0.05% or less, by weight based on the total weight of the coating composition. when an aqueous solution of the polyethylenimine and/or modified polyethylenimine are used, the concentration herein refers to the dry weight of the polyethylenimine and/or modified polyethylenimine relative to the total weight of the coating composition.

The coating composition of the present invention may comprise or be free of one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from TEGO, BYK-024 silicone deformer available from BYK, or mixtures thereof. The coating composition may comprise the defoamer at a concentration of from zero to 1%, from 0.05% to 0.8%, or from 0.1% to 0.5%, by weight based on the total weight of the coating composition.

The coating composition of the present invention may comprise or be free of one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. The coating composition may comprise the coalescent at a concentration of from zero to 10%, from 0.1% to 9%, or from 1% to 8%, by weight based on the total weight of the coating composition.

The coating composition of the present invention may comprise or be free of one or more thickeners (also known as “rheology modifiers”). Thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxydebutyl methyl cellulose, 2-hydroxyethyl ethyl cellulose, and 2-hydoxypropyl cellulose. Desirably, the thickener is HEUR. The thickener may be present at a concentration of from zero to 5%, from 0.1% to 3%, or from 0.2% to 1% by weight based on the total weight of the coating composition.

The coating composition of the present invention may comprise or be free of one or more wetting agents. “Wetting agents” herein refer to chemical additives that reduce the surface tension of a coating composition, causing the coating composition to more easily spread across or penetrate the surface of a substrate. Wetting agents may be anionic, zwitterionic, or non-ionic. The coating composition may comprise the wetting agent at a concentration of from zero to 2.5%, from 0.5% to 2.0%, or from 1% to 1.5%, by weight based on the total weight of the coating composition.

In addition to the components described above, the coating composition may further comprise any one or combination of the following additives: buffers, neutralizers, humectants, mildewcides, biocides, anti-skinning agents, colorants, flowing agents, anti-oxidants, plasticizers, leveling agents, adhesion promoters, and grind vehicles. When present, these additives may be present in a total amount of from zero to 10%, from 0.01% to 2%, or from 0.05% to 1%, by weight based on the total weight of the coating composition.

The coating composition of the present invention may comprise water typically at a concentration of from 20% to 70%, from 25% to 65%, or from 30% to 50%, by weight based on the total weight of the coating composition.

The coating composition of the present invention may be prepared by admixing the polyacid polymer, the emulsion polymer, the polyethylenimine and/or modified polyethylenimine, and the pigment and/or the extender, and optionally other ingredients described above. Desirably, the pigments and/or extenders are mixed with the polyacid polymer to form a slurry of the pigments and/or extenders. The obtained admixture may be then subjected to shearing in a grinding or milling device as is well known in the pigment dispersion art. Such grinding or milling devices include roller mills, ball mills, bead mills, attrittor mills and include mills in which the admixture is continuously recirculated. The shearing of the admixture is continued for a time sufficient to disperse the pigments and/or extenders. The emulsion polymer, the polyethylenimine and/or modified polyethylenimine, and other ingredients can be added to the pigment and/or extender grinds under low speed stirring to form the coating composition.

The coating composition of the present invention has good stability as indicated by a viscosity change of 20 Krebs Units (KU) or less after storage at 25° C. for 18 hours and further at 50° C. for 10 days (further details provided under Storage Stability Test below). The coating composition also provides coatings made therefrom with good washability, as indicated by the total number of cycles for cut-through not less than 200% comparing with a reference coating composition (i.e., CE-A in the Examples section below) (further details provided under Washability Test below).

The present invention also relates to a method of preparing a coating. The method may comprise (i) providing the coating composition, (ii) applying the coating composition to a substrate; and (iii) drying, or allowing to dry, the coating composition, thereby obtaining the coating. The coating has the improved washability as defined above. The coating composition can be applied to, and adhered to, various substrates. Examples of suitable substrates include wood, metals, plastics, foams, stones, elastomeric substrates, glass, fabrics, concrete, or cementitious substrates. The coating composition is suitable for various applications such as marine and protective coatings, automotive coatings, traffic paint, exterior insulation and finish systems (EIFS), roof mastic, wood coatings, coil coatings, plastic coatings, can coatings, architectural coatings, and civil engineering coatings. The coating composition is particularly suitable for architectural coatings for interior walls.

The coating composition of the present invention can be applied to a substrate by incumbent means including brushing, dipping, rolling and spraying. The coating composition is preferably applied by brushing or rolling or spraying. After the coating composition has been applied to a substrate, the coating composition can dry, or allow to dry, to form a film (this is, coating) at room temperature (20-25° C.), or at an elevated temperature, for example, from 35 to 60° C.

### EXAMPLES

Some embodiments of the invention will now be described in the following Examples. All weight-percent (wt %) values are relative to the composition weight.

Styrene (ST), acrylic acid (AA), ammonia persulfate (APS), phosphoethyl methacrylate (PEM), and ethylenediaminetetraacetic acid disodium (EDTA salt) are all available from The Dow Chemical Company.

Maleic anhydride (MA) is available from DuPont Specialty Colorants & Additives Company.

SILQUEST™ A-171 vinyltrimethoxysilane is available from Momentive Company.

DISPONIL™M FES 32 surfactant is available from BASF Global Corporation.

NATROSOL™M 250 HBR thickener, available from Aqualon, is a hydrophobic modified cellulose.

AMP-95, available from Angus, is 2-methyl-2-amino-propanol and used as a neutralizer.

Dimethylethylamine (DMEA) is available from Sinopharm Chemical Reagent Co., Ltd.

Propylene glycol is used as a solvent.

TRITON™ CF-10 surfactant, available from The Dow Chemical Company, is used as a wetting agent (TRITON is a trademark of The Dow Chemical Company).

Nopco NXZ defoamer is available from NOPCO.

Ti-Pure R-902 titanium dioxide, available from DuPont, is used as a pigment.

CC-700 calcium carbonate, available from Guangfu Building Materials Group (China), is used as an extender.

DB-80 calcined clay, available from Jinyang Gaoling Co., Ltd. (China), is used as an extender.

Wash clay, available from Guangzhou Bonny Chemical Co., Ltd. (China), is used as an extender. Texanol coalescent, available from Eastman, is trimethylpentanediol isobutyrate.

Table 1 lists polyethylenimines for use in synthesis of coating compositions of the samples described herein below.

TABLE 1

| PEI | Chemical description* | Commercial source |
|---|---|---|
| PEI-A | Polyethylenimine (PEI) with | Available as |
| | an average weight molecular | Lupasol FG from |
| | weight (Mw) of 2,448 g/mol | BASF |
| | (actives: 99 wt %) | |
| PEI-B | An aqueous solution of | Available as |
| | PEI with Mw of 4,305 g/mol | Lupasol G 20 from |
| | (actives: 50 wt %) | BASF |
| PEI-C | An aqueous solution of PEI | Available as |
| | with Mw of 9,400 g/mol | Lupasol G 100 from |
| | (actives: 50 wt %) | BASF |
| PEI-D | PEI with MW of 33,154 | Available as |
| | (actives: 99 wt %) | Lupasol WF from |
| | | BASF |
| PEI-E | An aqueous solution of | Available as |
| | PEI with Mw of 2,000,000 g/mol | Lupasol SK from |
| | (actives: 24 wt %) | BASF |

*Molecular weight of PEIs was measured according to GPC Analysis for Polyethylenimines described below.

The following standard analytical equipment and methods are used in the Examples and in determining the properties and characteristics stated herein:

### Storage Stability Test

In a 500 milliliter (mL) plastic bottle, a coating composition sample was prepared. Then the coating composition was cooled to 25° C., and the initial viscosity of the coating composition was measured and denoted as Initial KU¹. Then the coating composition was allowed to equilibrate at 25° C. for 18 hours, and then its viscosity was further measured and denoted as Final KU¹. The viscosity change (“delta KU (RT)”) is determined by Final KU¹ minus Initial KU¹.

Then, a portion of the coating composition (after equilibrium) obtained above was poured into a 200 mL plastic bottle, and the initial viscosity was measured and denoted as Initial KU². The plastic bottle was stored in an oven at 50° C. for 10 days, and then allowed to cool to 25° C. to test a final viscosity, denoted as Final KU². The heatage viscosity change (“delta KU (heatage)”) is determined by Final KU² minus Initial KU².

The total viscosity change (“Total ΔKU”) is calculated as:

Total ΔKU=delta KU (RT)+delta KU (heatage).

If a sample shows a Total ΔKU value of less than 20 KU then it passes storage stability test. Otherwise, a sample fails the storage stability test if it gels or shows a Total ΔKU value of 20 KU or above.

### Washability Test

An abrasion testing device (Wet Abrasion Scrub Tester REF 903, The Sheen Company), consisting of a brush from Modern instruments clamped into a bracket, was moved back and forth over the dried, applied paint film by means of a set of cables on either side. The abrasion tester was leveled before use and operated at 37 +1 cycles/min. Each time before starting the first test of the day, the brushes were soaked in a laundry solution (0.5% aqueous solution of BILANG detergent from P&G in deionized water) for 12 hours, then precondition the brushes, by running 400 cycles on a scrub panel, after which they were ready for test work. The aqueous coating composition was drawn down on a black vinyl chart (Type P-121-10N, The Leneta Company) using 175 micrometers (μm) applicator with 4 stripes. Among the 4 stripes, a reference paint was always included as the control in each chart. Four drawdowns were made for each sample. They were air-dried in a horizontal position for 7 days in an open room with constant temperature (25° C.) and humidity (50%). The drawdown was secured to the abrasion tester by using a gasketed frame and brass weights or clamps. The brush was mounted in the holder. A laundry solution (0.5 wt % aqueous solution of BILANG detergent from P&G in DI water) was added to the paint films constantly to keep the film wet during the process. The total number of cycles to remove the paint fully in one continuous line (“cut-through”) was recorded for each shim. The scrub removal cycles were reported by calculating the total average cut-through from all strips. A minimum of four measurements were used. Ratio expressed as a percentage of cycles-to-failure (“cut-through”) obtained on the test paint to that obtained on a concurrent run with the reference paint (control). The reference paint was CE-A listed in Table 4.

The requirement for passing the washability test is the ratio ≥200%. Otherwise, the ratio of less than 200% fails the washability test.

### GPC Analysis for Polyacid Polymer (Dispersant)

GPC analysis was performed generally by Agilent 1200. Samples were dissolved in 20 mM NaH₂PO₄ with a concentration 2 milligrams per milliliter (mg/mL) and the resultant solutions were clear. The sample solutions were filtered by 0.45 μm polyvinylidene fluoride (PVDF) membrane before the analysis. The GPC analysis is conducted using the following conditions:

Columns: One TSKgel guard column PWXL (6.0 millimeters (mm) *40 mm, 12 μm), One Tosoh TSKgel GMPWXL (13 μm, 7.8 mm*30 centimeters (cm)), and one Tosoh TSKgel G2500PWXL column (6 μm, 7.8 mm*30 cm) in tandem; column temperature: 35° C.; mobile phase: 20 mM phosphate in deionized (DI) water, pH=7; flow rate: 1.0 mL/minute; Injection volume: 100 μL; detector: Agilent Refractive Index detector, 35° C.; and calibration curve: PL Polyethylene Glycol standards (Part No.: 2070-0100) with molecular weights ranging from 1039000 to 106 g/mol, using polynom 3 fitness.

### GPC Analysis for Polyethylenimines

GPC analysis for polyethylenimines (PEIs) or modified PEIs was performed generally by Agilent 1200. A sample was dissolved in 0.1 mol/L sodium nitrate in DI water with a concentration of 2 mg/mL and then filtered through 0.45 μm PVDF filter prior to the analysis. The GPC analysis is conducted using the following conditions:

Columns: One TSKgel guard column PWXL (6.0 mm*40 mm, 12 μm), One TSK gel G6000 PWXL-CP columns (7.8 mm*30 cm, 7 μm), One TSK gel G5000 PWXL-CP columns (7.8 mm*30 cm, 7 μm), and One TSK gel G3000 PWXL-CP columns (7.8 mm*30 cm, 7 μm) in tandem; column temperature: 25° C.; mobile phase: 0.1 mol/L sodium nitrate in DI water; flow rate: 0.8 mL/minute; Injection volume: 100 μL; detector: Agilent Refractive Index detector, 25° C.; and calibration curve: PL Polyethylene Glycol standards (Part No.: 2070-0100) with molecular weights ranging from 1039000 to 194 g/mol, using polynom 3 fitness.

### Synthesis of Binder A

A monomer emulsion (ME) was prepared by combining 397.89 g of deionized (DI) water, 72.41 g of DISPONIL™ FES 32 anionic surfactant (31 wt % aqueous solution), 763.70 g of BA, 859.7 g of ST, 16.80 g of AA, 24.93 g of PEM, and 5.14 g of A-171. Then 8.04 g of DISPONIL FES 32 anionic surfactant (31 wt % aqueous solution) and 960 g of DI water were charged to a reactor with mechanical stirring. The materials in the reactor were heated to 90°° C. under nitrogen atmosphere. Then 54.72 g of the ME prepared above was added followed by an initiator solution (5.94 g APS in 29.88 g DI water). The remaining ME and another initiator solution (3.40 g APS in 298.8 g DI water) were added to the reactor over 120 minutes (min) while the reactor temperature was maintained at 88° C. Then, 31.87 g of DI water was used to rinse the emulsion feed line to the reactor. The contents of the reactor were then cooled down to 80° C. During cooling, 0.016 g of ferrous sulfate mixed with 0.016 g of EDTA salt in 9.35 g of DI water were charged into the reactor, followed by adding 5.86 g of t-butyl hydroperoxide (70 wt %) and 0.88 g of isoascorbic acid in aqueous solutions into the reactor. Then rinse the reactor by adding 54.58 g of DI water. Later, when the reactor temperature was less than 55° C., add 138 g of dimethylethylamine (DMEA) (50 wt %) into the reactor over 30 min to adjust pH to 8.5 to 9.5. Then filter to obtain a polymer emulsion (“Binder A”) with 45 wt % of solids and an average particle size of 98 nm as measured by Brookhaven BI-90Plus particle size analyzer.

### Synthesis of Binder B

The Binder B was prepared according to the same procedure as the synthesis of Binder A above except different monomers with the composition of 52.35% ST/45.7% BA/0.65% PEM/1% AA/0.3% A-171, by weight based on the total monomer weight, were used to give the Binder B with a pH value of 8.5 to 9.5, solids of 45 wt %, and an average particle size of 101 nm as measured by Brookhaven BI-90Plus particle size analyzer.

### Synthesis of Binder C

The Binder C was prepared according to the same procedure as in synthesis of Binder A above, except different monomers with the composition of 52.5% ST/45.2% BA/2% AA/0.3% A-171, by weight based on the total monomer weight, were used to give the Binder C with a pH value of 7.5, solids of 45.38 wt %, and an average particle size of 130 nm as measured by Brookhaven BI-90Plus particle size analyzer.

### Synthesis of Polyacid Polymer 1 (Dispersant 1)

To a 4.5 L reactor equipped with a mechanical stirrer, a condenser, a thermometer and inlets for the gradual additions of monomer, initiator and sodium bisulfite solutions, was added 390 g of DI water followed by 0.007 g of FeSO₄7H₂O in 3.5 g of DI water. The contents of the reactor were heated to 78° C., A monomer charge of 1214.2 g of acrylic acid and 582.4 g of DI water was prepared. A chain regulator solution prepared by 131.3 g of sodium bisulfite in 143 g of DI water. An initiator solution was prepared by dissolving 5.2 g of sodium persulfate in 160 g of DI water. The additions of separate feeds of the monomer charge, the chain regulator solution, and the initiator solution were simultaneously added into the heated stirring reactor over 90 min, while maintaining the contents of the reactor at 77-79° C. After the feeds were completed, the contents of the reactor were maintained at 77-79° C. for 30 min, adjusted to a pH of 6.5-8.5 by 1352.52 g of sodium hydroxide (50 wt % solids) solution, and then diluted to solids of 45 wt %.

### Synthesis of Polyacid Polymer 2 (Dispersant 2)

Dispersant 2 was prepared by the same procedure as described above in synthesis of Dispersant 1, except the chain regulator of used was 187.2 g of sodium bisulfite in 204 g of DI water and the neutralizer of 545.8 g of sodium hydroxide (50 wt % solids) solution to adjust pH to 6.5-8.5 and solid of 27%.

### Synthesis of Polyacid Polymer 3 (Dispersant 3)

A monomer #1 charge of 1679.2 g of acrylic acid was prepared. A monomer #2 charge of 158 g of maleic anhydride and 285.9 g of sodium hydroxide (50 wt % solids) in 388.3 g of DI water was prepared. An initiator solution was prepared by dissolving 46.6 g of sodium persulfate in 159.4 g of DI water. A neutralizer #1 was 1678.8 g of sodium hydroxide (50 wt % solids).

To a 4.5 L reactor equipped with mechanical stirrer, a condenser, a thermometer and inlets for the gradual additions of monomer, initiator and phosphorous acid solutions, was added 373 g of DI water followed by 471 g of sodium hydroxide (50 wt % solids) and a solution of 390 g of phosphorous acid solution (70 wt % solids) in 71 g of DI water. Then the contents of the reactor were heated to 90° C. The monomer #2 and the neutralizer #1 were fed over 100 min. One minute later, the monomer #1 and the initiator solution were further fed over 120 min. After the feeds were completed, the contents of the reactor were maintained at 90-92° C. for 30 min. Then add 21.7 g of 50 wt % aqueous solution of sodium hydroxide.

### Synthesis of Polyacid Polymer 4 (Dispersant 4)

To a 4.5 L reactor equipped with a mechanical stirrer, a condenser, a thermometer and inlets for the gradual additions of monomer, initiator and sodium hypophosphite solutions, was added 745 g of DI water. The contents of the reactor were heated to 94° C. An initiator solution #1 prepared by dissolving 0.97 g of sodium persulfate in 5 g of DI water. 1182 g of sodium hydroxide (50 wt % solids), the above prepared initiator solution #1 and 74.74 g of acrylic acid was charged into the reactor. A monomer of 1171 g of acrylic acid, an initiator solution #2 prepared by dissolving 31.39 g of sodium persulfate in 150 g of DI water, a neutralizer of 424 g of sodium hydroxide (50 wt % solids), and a chain regulator solution of 185.80 g of phosphorous acid solution (70 wt % solids) in 30 g of DI water were prepared. The additions of separate feeds of the monomer, neutralizer, the initiator solution and the regulator solution were simultaneously added into the heated stirring reactor over 150 min, while maintaining the contents of the reactor at 93-95° C. After the feeds were completed, the contents of the reactor were maintained at 93-95° C. for 30 min and diluted to solids of 49 wt % and a pH of 6.5-8.5.

### Synthesis of Polyacid Polymer 5 (Dispersant 5)

To a 4.5 L reactor equipped with a mechanical stirrer, a condenser, a thermometer and inlets for the gradual additions of monomer, initiator and sodium hypophosphite solutions, was added 692 g of DI water. The contents of the reactor were heated to 94° C. A chain regulator solution prepared by dissolving 132 g of phosphorous acid solution (70 wt % solids) in 25 g of DI water and 185 g of sodium hydroxide (50 wt % solids) was charged into the reactor. A monomer of 1089 g of acrylic acid, an initiator solution of 29.73 g of sodium persulfate in 130.2 g of DI water, and a neutralizer of 1099.63 g of sodium hydroxide (50 wt % solids) were prepared. The separate feeds of the monomer, the neutralizer, and the initiator solution were simultaneously added into the heated stirring reactor over 180 min, while maintaining the contents of the reactor at 93-95° C. After the feeds were completed, the contents of the reactor were maintained at 93-95° C. for 30 min and diluted to solids of 40 wt % and a pH value of 6-8.5.

Properties of the polyacid polymers obtained above are given in Table 2.

TABLE 2
Properties of polyacid polymer dispersant

| | Polyacid | Polyacid | Polyacid | Polyacid | Polyacid |
|---|---|---|---|---|---|
| | Polymer | Polymer | Polymer | Polymer | Polymer |
| Dispersant | 1 | 2 | 3 | 4 | 5 |
| Mw of polyacid | 17,940 | 12,583 | 10,733 | 12,912 | 14,863 |
| polymer1, g/mol | | | | | |

¹Mw (weight average molecular weight) was measured by GPC using PEG as standards (further details provided under GPC Analysis for Polyacid Polymer (Dispersant) above).

### Coating Composition Samples

PEI-A, PEI-B, PEI-C, and PEI-D, respectively, were first diluted with water to form diluted PEI solutions (i.e., Diluted PEI-A, Diluted PEI-B, Diluted PEI-C, and Diluted PEI-D, respectively), each with 33 wt % actives.

Tables 3 and 4 list formulations for preparing coating composition samples with the amount of each component reported in gram, unless otherwise stated. The dispersants and binders used in each sample were prepared as above. Firstly, components for forming the grind were mixed sequentially with a high speed Cowles disperser at 1,500 RPM for 30 min to form the grind. Then, components in the letdown were added to the grinds and mixed using a conventional lab mixer at 600 RPM for 30 min, thereby forming coating composition samples. PVC of each coating composition sample is given in Tables 3 and 4.

The resultant coating composition samples were characterized according to the test methods described above and characterization results are given in Tables 3 and 4.

TABLE 3
IEs 1-10 High PVC Coating Composition Samples

| Component | IE-1 | IE-2 | IE-3 | IE-4 | IE-5 | IE-6 | IE-7 | IE-8 | IE-9 | IE-10 |
|---|---|---|---|---|---|---|---|---|---|---|
| Grind | | | | | | | | | | |
| Water | 130 | 130 | 130 | 130 | 130 | 130 | 130 | 130 | 130 | 130 |
| NATROSOL 250 | 2.5 | 2.5 | 2.5 | 2.5 | 2.5 | 2.5 | 2.5 | 2.5 | 2.5 | 2.5 |
| HBR | | | | | | | | | | |
| AMP-95 | 0.1 | 0.1 | 0.1 | 0.1 | 0.1 | 0.1 | 0.1 | 0.1 | 0.1 | 0.1 |
| Diluted PEI-A | | | | 0.83 | | | | | | |
| Diluted PEI-B | | | | | 0.83 | | | | | |
| Diluted PEI-C | | | | | | 0.83 | | | | |
| Diluted PEI-D | 0.83 | 0.83 | 0.85 | | | | 0.83 | 0.2 | 0.83 | 0.83 |
| Propylene glycol | 10 | 10 | 10 | 10 | 10 | 10 | 10 | 10 | 10 | 10 |
| Dispersant 3 | 3.6 | | | 3.6 | 3.6 | 3.6 | 3.6 | 3.6 | 3.6 | 3.6 |
| Dispersant 4 | | 3.6 | | | | | | | | |
| Dispersant 5 | | | 4.61 | | | | | | | |
| TRITON CF-10 | 1.13 | 1.13 | 1.13 | 1.13 | 1.13 | 1.13 | 1.13 | 1.13 | 1.13 | 1.13 |
| Nopco NXZ | 0.6 | 0.6 | 0.6 | 0.6 | 0.6 | 0.6 | 0.6 | 0.6 | 0.6 | 0.6 |
| Ti-Pure R-902 | 25 | 25 | 25 | 25 | 25 | 25 | 25 | 25 | 25 | 25 |
| CC-700 | 162.5 | 162.5 | 162.5 | 162.5 | 162.5 | 162.5 | 162.5 | 162.5 | 162.5 | 162.5 |
| DB-80 | 37.5 | 37.5 | 37.5 | 37.5 | 37.5 | 37.5 | 37.5 | 37.5 | 37.5 | 37.5 |
| Wash clay | 20 | 20 | 20 | 20 | 20 | 20 | 20 | 20 | 20 | 20 |
| LetDown | | | | | | | | | | |
| Binder A | 56.65 | 56.65 | 56.65 | 56.65 | 56.65 | 56.65 | | 56.65 | 62.94 | 43.16 |
| Binder B | | | | | | | 55.53 | | | |
| Texanol | 2.02 | 2.02 | 2.02 | 2.02 | 2.02 | 2.02 | 2.02 | 2.02 | 2.25 | 2.02 |
| Nopco NXZ | 0.25 | 0.25 | 0.25 | 0.25 | 0.25 | 0.25 | 0.25 | 0.25 | 0.25 | 0.25 |
| Water | 47.32 | 47.32 | 46.29 | 47.32 | 47.32 | 47.32 | 48.44 | 47.95 | 40.8 | 60.81 |
| Total | 500 | 500 | 500 | 500 | 500 | 500 | 500 | 500 | 500 | 500 |
| Characterization | | | | | | | | | | |
| PEM level¹, wt % | 1.5 | 1.5 | 1.5 | 1.5 | 1.5 | 1.5 | 0.65 | 1.5 | 1.5 | 1.5 |
| PEI level² | 0.05% | 0.05% | 0.05% | 0.05% | 0.05% | 0.05% | 0.05% | 0.01% | 0.05% | 0.05% |
| PVC³, % | 80 | 80 | 80 | 80 | 80 | 80 | 80 | 80 | 78 | 84 |
| Total ΔKU (RT + | 9.1 | 11.9 | 15.8 | 19.8 | 18.9 | 17.3 | 11.2 | 17.3 | 13.8 | 19.4 |
| 50° C., 10 days) | | | | | | | | | | |
| Washability | 295% | 280% | 243% | 220% | 237% | 243% | 261% | 230% | 200% | 512% |

¹PEM level refers to weight percentage of PEM relative to the total monomer weight for preparing the binder.
²PEI level refers to weight percentage of dry weight of PEI solutions relative to the total weight of aqueous coating composition sample.
³PVC = [Volume (Pigment + Extender)/Volume (Pigment + Extender + Emulsion polymer in Binder)] × 100%.

TABLE 4
CEs A-I High PVC Coating Composition Samples

| | CE-A | CE-B | CE-C | CE-D | CE-E | CE-F | CE-G | CE-H | CE-I |
|---|---|---|---|---|---|---|---|---|---|
| Grind | | | | | | | | | |
| Water | 130 | 130 | 130 | 130 | 130 | 130 | 130 | 130 | 130 |
| NATROSOL 250 | 2.66 | 2.66 | 2.5 | 2.5 | 2.66 | 2.5 | 2.5 | 2.5 | 2.5 |
| HBR | | | | | | | | | |
| AMP-95 | 0.53 | 0.53 | 0.1 | 0.1 | 0.53 | 0.1 | 0.1 | 0.1 | 0.1 |
| Diluted PEI-D | | | 0.83 | 0.83 | | | 3.32 | 0.83 | 0.83 |
| PEI-E | | | | | | 1.14 | | | |
| Propylene glycol | 10 | 10 | 10 | 10 | 10 | 10 | 10 | 10 | 10 |
| Dispersant 1 | 4 | 4 | 4.1 | | | | | | |
| Dispersant 2 | | | | 6.7 | | | | | |
| Dispersant 3 | | | | | 3.6 | 3.6 | 3.6 | 3.6 | 3.6 |
| TRITON CF-10 | 1.13 | 1.13 | 1.13 | 1.13 | 1.13 | 1.13 | 1.13 | 1.13 | 1.13 |
| Nopco NXZ | 0.6 | 0.6 | 0.6 | 0.6 | 0.6 | 0.6 | 0.6 | 0.6 | 0.6 |
| Ti-Pure R-902 | 25 | 25 | 25 | 25 | 25 | 25 | 25 | 25 | 25 |
| CC-700 | 162.5 | 162.5 | 162.5 | 162.5 | 162.5 | 162.5 | 162.5 | 162.5 | 162.5 |
| DB-80 | 37.5 | 37.5 | 37.5 | 37.5 | 37.5 | 37.5 | 37.5 | 37.5 | 37.5 |
| Wash clay | 20 | 20 | 20 | 20 | 20 | 20 | 20 | 20 | 20 |
| LetDown | | | | | | | | | |
| Binder C | 52.5 | | | | | | | | |
| Binder A | | 56.65 | 56.65 | 56.65 | 56.65 | 56.65 | 56.65 | 97.11 | 32.37 |
| Texanol | 2.02 | 2.02 | 2.02 | 2.02 | 2.02 | 2.02 | 2.02 | 3.46 | 2.02 |
| Nopco NXZ | 0.25 | 0.25 | 0.25 | 0.25 | 0.25 | 0.25 | 0.25 | 0.25 | 0.25 |
| Water | 51.31 | 47.16 | 46.82 | 44.22 | 47.56 | 47.01 | 44.83 | 5.42 | 71.6 |
| Total | 500 | 500 | 500 | 500 | 500 | 500 | 500 | 500 | 500 |
| Characterization | | | | | | | | | |
| PEM level¹, wt % | 0 | 1.5 | 1.5 | 1.5 | 1.5 | 1.5 | 1.5 | 1.5 | 1.5 |
| PEI level² | 0 | 0 | 0.05% | 0.05% | 0 | 0.05% | 0.22% | 0.05% | 0.05% |
| PVC³, % | 80 | 80 | 80 | 80 | 80 | 80 | 80 | 70 | 88 |
| Total ΔKU (RT + | 0.1 | 30.4 | 21.7 | 22.3 | 5.9 | 14.2 | 30.3 (gel) | 17.6 | 29.8 |
| 50° C., 10 days) | | | | | | | | | |
| Washability | 100% | 268% | 298% | 342% | 156% | 180% | 454% | 171% | 300% |

¹PEM level,
²PEI level, and
³PVC are as defined in Table 3 above.

As shown in Table 3, all IEs 1-10 samples met both requirements for good stability (i.e., Total ΔKU <20 KU) and excellent washability (i.e., >200% comparing with CE-A). Comparing samples IE-1, IE-2 and IE-3, samples comprising dispersants with lower Mw showed better stability.

In contrast, Table 4 illustrates that compositions that deviated from one or more requirements of the composition of the present invention failed to provide one or both of requirements for stability and washability. CE-B, CE-C and CE-D samples comprising Dispersant 1 or Dispersant 2 both prepared in the absence of any phosphorus chain transfer agents and Binder A showed good washability but poor storage stability, with or without PEI-D. CE-E sample comprising Binder A and Dispersant 3 (a phosphonate and/or phosphinate functional polyacid polymer), in the absence of PEI, showed the best stability, but couldn't meet the washability requirement. CE-F sample comprising PEI-E with a Mw of 2000,000 g/mol failed the washability requirement. CE-G sample comprising 0.22 wt % of PEI provided poor storage stability. Samples with too low or too high PVC either failed the washability requirement or showed poor storage stability (CE-H and CE-I).

1. An aqueous coating composition comprising:
(A) a polyacid polymer containing a phosphonate and/or phosphinate functional group, wherein the polyacid polymer has a weight average molecular weight of 2000 to 25000 grams per mole and comprises, by weight based on the weight of the polyacid polymer, from 20% to 100% of structural units of an acid monomer, a salt thereof, or mixtures thereof; and from zero to 80% of structural units of an ethylenically unsaturated nonionic monomer;
(B) an emulsion polymer comprising, by weight based on the weight of the emulsion polymer, from 0.3% to 2.5% of structural units of an ethylenically unsaturated phosphorous-containing acid monomer, a salt thereof, or mixtures thereof;
from zero to 10% of structural units of an additional acid monomer, a salt thereof, or mixtures thereof; and
structural units of an ethylenically unsaturated nonionic monomer;
(C) from 0.005% to 0.15%, by weight based on the weight of the aqueous coating composition, of a polyethylenimine, a modified polyethylenimine, or mixtures thereof; having a weight average molecular weight of 500 to 50000 grams per mole; and
(D) a pigment, an extender, or mixtures thereof;
wherein the coating composition has a pigment volume concentration of 78% to 86%.

2. The aqueous coating composition of claim 1, wherein the modified polyethylenimine is selected from an amidated polyethylenimine, an alkoxylated polyethylenimine, a carboxylated polyethylenimine, or mixtures thereof.

3. The aqueous coating composition of claim 1, wherein the ethylenically unsaturated phosphorous-containing acid monomer and/or salt thereof are selected from phosphoethyl methacrylate, phosphoethyl acrylate, allyl ether phosphate, phosphopropyl methacrylate, phosphobutyl methacrylate, or mixtures thereof.

4. The aqueous coating composition of claim 1, wherein the polyacid polymer comprises, by weight based on the weight of the polyacid polymer, from 70% to 100% of structural units of an ethylenically unsaturated carboxylic acid monomer, and from zero to 30% of structural units of the ethylenically unsaturated nonionic monomer.

5. The aqueous coating composition of claim 1, wherein the polyacid polymer has a weight average molecular weight of 5000 to 18000 grams per mole.

6. The aqueous coating composition of claim 1, wherein the polyacid polymer is prepared by polymerization of monomers comprising the acid monomer, the salt thereof, or mixtures thereof; and
optionally, the ethylenically unsaturated nonionic monomer; in the presence of a phosphorus chain transfer agent.

7. The aqueous coating composition of claim 1, wherein the emulsion polymer comprises, by weight based on the weight of the emulsion polymer, from 0.5% to 1.8% of structural units of the ethylenically unsaturated phosphorous-containing acid monomer, the salt thereof, or mixtures thereof.

8. The aqueous coating composition of claim 1, comprising from 0.3% to 1.2% of the polyacid polymer, by weight based on the total weight of the pigment and extender.

9. The aqueous coating composition of claim 1, wherein the pigment volume concentration is in a range of 78% to 84%.

10. A process for preparing the aqueous coating composition of claim 1, comprising admixing the polyacid polymer (A), the emulsion polymer (B), the polyethylenimine, the modified polyethylenimine, or mixtures thereof (C), and the pigment, the extender, or mixtures thereof (D).

11. The aqueous coating composition of claim 1, wherein the phosphonate and/or phosphinate functional group in the polyacid polymer is as illustrated by (I), (II), (III) or combinations thereof: 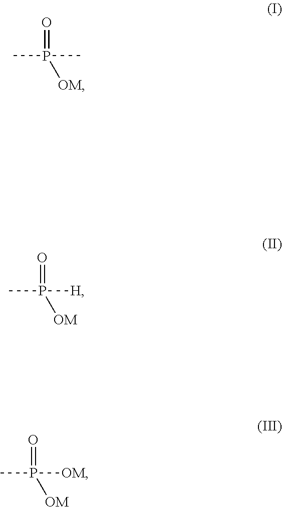
where the dotted lines represent the points of attachment of the phosphinate and/or phosphonate functional group to the polymer backbone, and M represents H or a metal ion.

12. The aqueous coating composition of claim 6, wherein the chain transfer agent is selected from hypophosphorous acid or phosphorous acid; salts thereof, or combinations thereof.
